(19) United States
(12) Patent Application Publication
(10) Pub. No.: US 2013/0026091 A1
(43) Pub. Date: Jan. 31, 2013

(54) METHOD TO IMPROVE FORWARD OSMOSIS MEMBRANE PERFORMANCE

(71) Applicants: Isaac V. Farr, Corvallis, OR (US); Upen J. Bharwada, Scottsdale, AZ (US); Tilak Gullinkala, Perrysburg, OH (US)

(72) Inventors: Isaac V. Farr, Corvallis, OR (US); Upen J. Bharwada, Scottsdale, AZ (US); Tilak Gullinkala, Perrysburg, OH (US)

(73) Assignee: HYDRATION SYSTEMS, LLC, Scottsdale, AZ (US)

(21) Appl. No.: 13/559,472

(22) Filed: Jul. 26, 2012

Related U.S. Application Data
(60) Provisional application No. 61/511,877, filed on Jul. 26, 2011.

(51) Int. Cl. B01D 71/68; B05D 3/10; B05D 5/00; B01D 71/64; B01D 71/60; B01D 71/28; B01D 71/42; B05D 3/02; B01D 69/12

(52) U.S. Cl. 210/500.34; 427/244; 210/500.27; 210/500.41; 210/500.33; 210/500.28; 210/500.42; 210/500.43; 210/500.39

(57) ABSTRACT

Described herein are thin film composite (TFC) membranes, for use in forward osmosis (FO) and pressure reduced osmosis (PRO) processes. The membrane is comprised of two layers: a composite layer combining a backing layer and a porous, polymer-based support into a single layer, and a rejection layer disposed on top of the composite layer. The membrane of the invention exhibits high water flux values for FO processes, is durable, may be readily manufactured using typical membrane manufacturing processes, such as spiral winding and plate and frame processes, and has sufficient mechanical stability to handle the final membrane product.

### CROSS REFERENCE TO RELATED APPLICATIONS

This application claims priority to U.S. Provisional Application No. 61/511,877 filed on Jul. 26, 2011, the entire specification of which is incorporated herein by reference thereto.

### FIELD OF THE INVENTION

The invention relates to thin-film composite membranes for osmosis processes for removing contaminants from water and concentrating and diluting liquids containing a significant amount of water.

### BACKGROUND

Thin film composite membranes were originally developed for the reverse osmosis (RO) industry. The basic construction of these types of membranes consists of three layers: 1) a backing material for strength, 2) a porous polymer-based support formed on top of the backing material, and 3) a rejection layer on top of the porous support. Water flux is the rate of flow of water across the membrane. The rejection layer is also knows as the selection layer.

The three layer membranes typically have a thickness of about 180 microns or more. For RO membranes, this construction works well because the water flux depends only on the rejection layer, not on the underlying porous support. However, this construction is not ideal as a forward osmosis (FO) membrane, because in FO processes the water flux is defined by both the rejection layer as well as the two underlying layers (the support and backing layers).

Commercially available FO membranes are typically based on cellulose triacetate (CTA). CTA-based FO membranes are available with either woven or non-woven backing materials. The woven-backed membranes show a distinct advantage over the non-woven backing due to a reduced diffusional barrier to osmotic agent migration within the support layer as well as the overall thinness of the membrane that can be produced. However, CTA-based FO membranes have the drawbacks that they are highly sensitive to pH and are slow from a water flux standpoint. It has been reported that thin film composites (TFC) membranes yield higher water fluxes and better salt rejection properties compared to the cellulose triacetate (CTA) membranes. However, the traditional three layer construction of TFC RO membranes is not amenable to high performance in FO due to the relatively thick non-woven backing layer.

### SUMMARY OF THE INVENTION

Described herein are thin film composite (TFC) membranes, for use in forward osmosis (FO) and pressure retarded osmosis (PRO) processes. The membrane is comprised of two layers: a composite layer combining a backing layer and a porous, polymer-based support layer into a single layer, and a rejection layer disposed on top of the composite layer. The membrane of the invention exhibits high water flux values for FO processes, is durable, may be readily manufactured using typical membrane manufacturing processes, such as spiral winding and plate and frame processes, and has sufficient mechanical stability to handle the final membrane product.

### DETAILED DESCRIPTION OF THE INVENTION

In RO the rate limiting step to water transport is the quality of the rejection layer. However, in FO processes the rate limiting step often is not the rejection layer, but is the polymer-based support layer (also referred to herein as the polymeric support layer). Because of this unique difference, FO membrane designs are fundamentally different than RO membrane designs.

In RO, the flux of the membrane is overwhelmingly dependent on the thickness, composition and morphology of the rejection layer, so there has been little impetus to optimize the performance of the porous layer. However in FO processes, the osmotic agents that are in contact with, and that are within, the polymeric support layer significantly influence the water flux performance. If the higher osmotic agent concentration is on the porous layer side of the dense layer, the water being pulled through the dense layer necessarily displaces the osmotic agents that drove the water transport initially. However, for this process to continue driving a high water flux, the osmotic agent must diffuse upstream through the porous layer to the dense layer. The support design plays a critical role in maximizing the steady-state water flux for any given FO membrane.

There are many features of method implementations disclosed herein that increase the water flux performance of FO membranes, of which one, a plurality, or all features or steps may be used in any particular implementation. In the following description, it is to be understood that other implementations may be utilized, and structural, as well as procedural, changes may be made without departing from the scope of this document. As a matter of convenience, various components may be described using exemplary materials, sizes, shapes, dimensions, and the like. However, this document is not limited to the stated examples and other configurations are possible and within the teachings of the present disclosure.

Described herein is a method for increasing the water flux performance of forward osmosis (FO) membranes by incorporating an embedded support material into the thin film composite (TFC) structure in order to facilitate a reduced thickness of the porous support layer while providing sufficient mechanical stability required by the final membrane product.

Further described herein is a TFC membrane structure comprised of two layers. The first layer is comprised of a single layer composite support layer that combines a backing layer and a porous polymer-based support. More particularly, the first layer is comprised of a backing material and a porous polymer-based support combined into one, substantially inseparable matrix. As used in this specification, the term “substantially inseparable matrix” means that the backing material is essentially embedded within a matrix of the porous polymer-based support material, so that during normal use, the two components cannot be readily separated from one another.

The backing material is a woven or non-woven fabric material. Preferably, it is a woven fabric material. The material may be made of any material known to one of ordinary skill in the art for use in osmotic membranes, particularly RO and/or FO membranes. Generally, it is preferred that the fabric be thin and provide open passageways between the fibers of the fabric.

The second layer of the TFC membrane structure is a rejection layer. More particularly, the second layer is a very thin rejection layer which is deposited on the first layer. The very thin rejection layer deposited onto the composite layer is the portion of the membrane which allows the passage of water while blocking other species such as salts and organic matter.

Materials for the second layer are those known to those of ordinary skill in the art for use in rejection layers of RO, FO and other osmotic membranes.

Also described herein is a two-step process to form a two-layer, high water flux, mechanically robust membrane by embedding a support structure within the porous support material during the fabrication process, followed by the addition of a thin second layer which serves as the rejection layer.

The process forms a high water flux and mechanically robust membrane wherein the composite first layer is produced by combining the backing material and the porous polymer-based support into one, inseparable matrix. Then, a very thin rejection layer is deposited onto the composite first layer. The result is the formation of a two-layered TFC membrane (a thin, mechanically robust membrane that yields high water flux values). The process produces a membrane that is relatively thinner as compared with prior art FO membranes. The overall thinner membrane will minimize internal concentration polarization (ICP) and ultimately produce a higher flux membrane.

The porous composite support layer acts as a support for this rejection layer and is comprised of two elements, the backing and the porous polymeric material. The backing that is incorporated into the porous polymeric matrix is preferably woven, but may be non-woven. The woven backing is preferred over a non-woven backing material for two key reasons: the woven backing yields membranes with sufficient mechanical integrity required for standard membrane manufacturing practices, and the woven backing simultaneously minimizes water transport resistance due to the inherent large openings in the backing structure.

To create the first layer composite support structure, the immersion precipitation process, such as described in U.S. Pat. No. 3,133,132, (which is hereby incorporated herein in its entirety), may be employed. First, a membrane polymeric material, particularly a hydrophilic polymer (e.g., polysulfone (PS), polyethersulfone (PES), sulfonated polysulfone, sulfonated polyethersulfone and mixtures thereof) is dissolved in water-soluble solvent (e.g., a non-aqueous solvent, such as N-methylpyrrolidone and the like) system to form a viscous solution.

Next, a thin layer of the viscous solution is metered onto a casting drum surface followed by embedding a highly porous fabric into the viscous solution. Examples of such fabrics are described in U.S. Pat. No. 3,133,132 (which is hereby incorporated by reference). That is, the solution may be cast onto a rotating drum and an open fabric may be pulled into the solution so that the fabric is embedded into the solution.

After air drying for a short time (e.g., under an air knife), the liquid pre-membrane composite may then be quickly immersed into a coagulation bath (e.g., water bath) to solidify the viscous polymer solution. The coagulation bath causes the membrane components to coagulate and form the appropriate membrane characteristics (e.g., porosity, hydrophilic nature, asymmetric nature, and the like). Thus, the water contact causes the polymer in solution to become unstable and a layer of dense polymer precipitates on the surface very quickly. This layer acts as an impediment to water penetration further into the solution so the polymer beneath the dense layer precipitates much more slowly and forms a loose, porous matrix around the embedded fabric.

Then, after all the polymer is condensed from the viscous solution the membrane can be washed and heat treated, if needed. Thus, the immersion/precipitation process may form a porous composite support layer with either macro-, ultra-, or nano-filtration sized pores. The composite support layer has its porosity controlled by both casting parameters (time, temperature, standard techniques, and the like) and by the choices of formulation components (solvent, ratio of solids of polymeric material to solvent solution, and the like).

The rejection layer is formed from a thin coating of a hydrophilic polymer. To add the rejection layer onto the composite support layer various options are available. The composite support layer may be coated with a pre-formed polymer or a polymer may be formed via in situ polymerization. Examples of polymers which may be used are, polyvinyl alcohol (PVA), polyacrylonitrile, sulfonated polysulfone, sulfonated polyethersulfone, sulfonated polyetherketone, sulfonated polyetheretherketone, sulfonated polyimides, sulfonated styrenic block copolymer, such as those available from Kraton, and the like, as well as mixtures of the foregoing. Forming the rejection layer using pre-formed polymer may be accomplished using a variety of means, for example an extrusion head process, a knife-over process, or a float coating process.

Alternatively, a polymer such as polyamide may be polymerized in situ on the composite support layer to form the rejection layer. For the in situ interfacial polymerization of polyamide, the composite support layer is first soaked in an aqueous solution of m-phenylenediamine (m-PDA). Excess m-PDA is removed from the surface with a roller or an air knife and a solution of trimesoyl chloride (TMC) in an organic fluid, such as hexane or Isopar G, is applied to the top surface of the amine-soaked composite support layer. Interfacial polymerization occurs to yield a thin polyamide rejection layer on the composite support layer. Coatings of thicknesses one (1) micron or less (e.g., 0.2 micron) are readily achievable.

Thus, the result is the formation of a two-layered TFC membrane. It is a thin, mechanically robust membrane that yields high water flux values in FO processes.

In most instances, a thinner membrane is favored. Generally speaking, the more open the backing material (i.e., the more spaces between the fibers) used to produce the membrane, the better the functionality of the membrane. However, some applications of the membranes of the invention may require a thicker rather than a thinner membrane. It is the thickness of the backing material used in the first layer that tends to determine how thick the membrane will be. Moreover, if the backing material itself has variations in thickness, these variations may be accommodated by making the remainder of the membrane thicker.

It is preferred that the thickness of the membrane be less than about 130 microns and greater than about 30 microns. However, thicknesses of greater than 130, such as about 200 or even greater are possible and may be desirable for some uses of the membranes. Preferably, the thickness of the membrane will be about 100 microns. In one exemplary embodiment, the thickness of the membrane is about 120 microns. In two other embodiments, the respective thicknesses of the membranes are 80 and 100.

Optionally, additional components can be incorporated into the first layer. For example, at the beginning of the process prior to casting the following can be included/mixed in the viscous solution of the membrane polymeric material dissolved in water-soluble solvent: pore-forming agents (e.g., agents to optimize the porosity of the support layer, such as polyethylene glycol, organic acids, organic acid salts, mineral salts, amides, polymers, and the like, such as maleic acid, citric acid, lactic acid, lithium chloride, lithium bromide, polymers such as polyvinylpyrrolidone (PVP), polyethersulfone (PES), polyphenylene sulfide (PPS) and co-polymers of the foregoing polymers), hydrophilizing agents (e.g., PVP, polydopamine, polyvinylpyrrolidone (PVP), and co-polymers of polyvinylpyrollidone and the like) and strengthening agents (e.g., agents to improve pliability and reduce brittleness, such as methanol, ethanol, glycerol, acetone and solvents such as DMAc, DMF and DMSO and the like).

Optionally, once formed, the resulting two-layered TFC membrane can be further treated with a hydrophilizing agent to increase water wettability (to make the membrane more hydrophilic). More specifically, the first layer (i.e., the composite layer incorporating the polymer-based support) may be coated with a hydrophilizing agent on the surface of the first layer opposite the rejection layer. Examples of hydrophilizing agents that may be used are polydopamine, polyvinylpyrrolidone (PVP), and co-polymers of polyvinylpyrollidone and the like.

Other optional membrane formation steps may be employed to optimize the performance of the resulting membrane. For example, the two-layer membrane can be further subjected to thermal treatments, chemical treatments (e.g., NaOCl followed by NaHSO₃) and surface modifications, such as grafting polyethylene glycol, to improve anti-fouling properties, water flux, salt rejection, long-term performance, and the like.

Described below are examples of two-layered TFC membranes according to the invention.

Microporous polysulfone substrates were prepared from a casting solution of the formulation given in Table 1. The woven backing for the support membrane is incorporated into a thin layer of this casting solution to lend strength for manufacturing and end-used durability. This composite structure was then immersed into water which served as the non-solvent and caused the membrane to form by precipitating the polymer.

TABLE 1

| Formulations | | | | |
|---|---|---|---|---|
| for Forming | | | | |
| the Support | Support | Support | Support | Support |
| Membranes | Membrane-1 | Membrane-2 | Membrane-3 | Membrane-4 |
| PSf 3500 | 17.5 | 17.5 | 17.5 | 17.5 |
| (Solvay) | | | | |
| (polysulfone), | | | | |
| wt % | | | | |
| PVP (1.3M) | 0.5 | 0.5 | 0.5 | 0.5 |
| (Sigma), wt % | | | | |
| NMP (Sigma), | 82 | 82 | 82 | 82 |
| wt % | | | | |
| total, wt % | 100 | 100 | 100 | 100 |

In addition to what is described in Table 1, further optional components that may be added to solution formulations are pore forming agents such as polyethylene glycol, maleic acid, citric acid, lactic acid, lithium chloride, lithium bromide, polymers such as PVP, polyethersulfone (PES) and polyphenylene sulfide (PPS) and co-polymers of the foregoing polymers, surfactants such as SLS and SDBS, non-solvents such as water, methanol, ethanol, glycerol, acetone and solvents such as DMAc, DMF and DMSO. To those skilled in the art there is a wide range of materials use for the preparation of reverse osmosis membranes that can also be applied to forward osmosis membranes.

Through interfacial polymerization, a rejection layer comprising a thin film of polyamide (PA) was deposited onto the membranes using the formulations provided in Table 2, which also contains the process variables that were used in combination with these formulas.

TABLE 2

| | Support | Support | Support |
|---|---|---|---|
| | Membrane-1 | Membrane-2 | Membrane-3 |
| PA Coating | | | |
| Formulation | | | |
| Aqueous phase | | | |
| m-PD, wt % | 2 | 2 | 2 |
| water, wt % | 98 | 98 | 98 |
| total, wt % | 100 | 100 | 100 |
| Organic phase | | | |
| TMC, wt % | 0.1 | 0.1 | 0.1 |
| Hexane, wt % | 99.9 | 99.9 | 99.9 |
| total, wt % | 100 | 100 | 100 |
| PA Coating Process | | | |
| Parameters | | | |
| Aqueous phase soak | 5 | 5 | 10 |
| time, min | | | |
| Method of removing | roller | roller | roller |
| excess Aqueous phase | | | |
| Organic phase soak time, | 10 | 10 | 10 |
| sec | | | |
| Oven time (min.)/ | none/none | 45/70 | none/none |
| Temperature (° C.) | | | |

Once these membranes were prepared, they were tested in both FO and PRO modes and the data is summarized in Table 3. Both water flux and reverse salt transfer data is presented.

TABLE 3
FO Mode and PRO Mode Performance Results

| | | | | | Draw Side | Feed Side | | Reverse |
|---|---|---|---|---|---|---|---|---|
| | Membrane | | Draw | | Crossflow | Crossflow | Water | Salt |
| Membrane | Test | Thickness | Solution | | Velocity | Velocity | Flux | Transfer |
| (name) | Orientation | (mils) | (% NaCI) | Feed Solution | (m/s) | (m/s) | (LMH) | (mg/L) |
| TFC-1 | FO Mode | 7.5 | 5.0 | Deionized Water | 0.3 | 0.3 | 10.0 | 1637 |
| | PRO Mode | 7.5 | 5.0 | Deionized Water | 0.3 | 0.3 | 16.3 | 1723 |
| TFC-2 | FO Mode | 4.2 | 5.0 | Deionized Water | 0.3 | 0.3 | 7.6 | 553 |
| | PRO Mode | 4.2 | 5.0 | Deionized Water | 0.3 | 0.3 | 12.4 | 691 |
| TFC-3 | FO Mode | 4.2 | 5.0 | Deionized Water | 0.3 | 0.3 | 13.6 | 349 |
| | PRO Mode | 4.2 | 5.0 | Deionized Water | 0.3 | 0.3 | 18.7 | 721 |

Implementations of a two-layered TFC membrane are particularly useful in FO water treatment applications. Such applications may include osmotic-driven water purification and filtration, desalination of sea water, purification of contaminated aqueous waste streams, membrane bioreactors, and the like. However, implementations are not limited to uses relating to FO applications. Rather, any description relating to FO applications is for the exemplary purposes of this disclosure, and implementations may also be used with similar results in a variety of other applications. For example, two-layered TFC membrane implementations may also be used for PRO systems. The difference is that PRO generates osmotic pressure to drive a turbine or other energy-generating device. All that would be needed is to switch to feeding fresh water (as opposed to osmotic agent) and the salt water feed can be fed to the outside instead of source water (for water treatment applications).

1. A thin film composite osmosis membrane having two layers, said layers comprising:
(a) a composite layer comprising a backing layer embedded in a porous polymer-based support; and
(b) a rejection layer disposed on the composite layer.

2. The membrane of claim 1, wherein the backing layer is a non-woven or a woven fabric.

3. The membrane of claim 2, wherein the backing layer is a woven fabric.

4. The membrane of claim 1, wherein the porous polymer-based support is formed from a hydrophilic polymer.

5. The membrane of claim 4, wherein the porous polymer-based support is formed from a polymer selected from the group consisting of polysulfone, polyethersulfone, sulfonated polysulfone and sulfonated polyethersulfone and mixtures thereof.

6. The membrane of claim 4, wherein the composite layer has incorporate therein or coated thereon a hydrophilic polymer is selected from the group consisting of polyvinylpyrrolidone, polyvinylpyrrolidone co-polymers, polydopamine, and mixtures thereof.

7. The membrane of claim 2, wherein the rejection layer is a hydrophilic polymer.

8. The membrane of claim 7, wherein the rejection layer is a hydrophilic polymer selected from the group consisting of, polyvinyl alcohol, polyacrylonitrile, sulfonated polysulfone, sulfonated polyethersulfone, sulfonated polyetherketone, sulfonated polyetheretherketone, sulfonated polyimides, sulfonated styrenic block copolymers and mixtures thereof.

9. The membrane of claim 1 having a thickness of about 30 to about 130 microns.

10. A method of forming a two-layer thin film composite membrane comprising:
combining backing material and a porous polymer-based support into an inseparable matrix to form a composite support layer; and
forming a rejection layer on the composite support layer, thereby forming the membrane.

11. The method of claim 10 wherein the composite support layer is formed by embedding the backing material into a solution of hydrophilic polymer.

12. The method of claim 11, wherein the backing material is embedded into the solution of hydrophilic polymer by casting the solution on a rotating drum and pulling the backing material into the solution.

13. The method of claim 11, wherein the solution of hydrophilic polymer further comprises a pore-forming agent, a hydrophilizing agent or a strengthening agent.

14. The method of claim 11 further comprising immersing the composite support material in a coagulation bath prior to forming the rejection layer.

15. The method of claim 10 wherein the rejection layer is formed by an extrusion head process, a knife-over process, a float coating process or by polymerizing a polymer in situ on the composite support layer.

16. The method of claim 15 wherein the rejection layer is formed in situ on the composite support layer, by soaking the composite support layer in a solution of m-phenylenediamine and then applying a solution of trimesoly chloride in an organic fluid is to a top surface of the composite support layer.

17. The method of claim 10, further comprising subjecting the membrane to a treatment selected from the group consisting of: thermal treatment, chemical treatment, and surface modification.

18. The method of claim 10, further comprising subjecting the composite support layer side of the membrane to treatment with a hydrophilizing agent.
